(19) United States
(12) Patent Application Publication
(10) Pub. No.: US 2003/0204419 A1
(43) Pub. Date: Oct. 30, 2003

(54) Automated messaging center system and method for use with a healthcare system

(76) Inventors: Gordon J. Wilkes, Newmarket (CA); Meetali Acharya, Burlington (CA); Eric S. Paul, North York (CA); Sayeh Radpay, Toronto (CA); Kaivan Talachian, Richmond Hill (CA)

Correspondence Address: Wallenstein & Wagner, Ltd., 53rd Floor, 311 S. Wacker Drive, Chicago, IL, 60606-6622, US

(21) Appl. No.: 10/159,845

(22) Filed: May 31, 2002

Related U.S. Application Data
(63) Continuation-in-part of application No. 10/135,180, filed on Apr. 30, 2002.
(60) Provisional application No. 60/377,027, filed on Apr. 30, 2002.
(60) Provisional application No. 60/376,625, filed on Apr. 30, 2002.
(60) Provisional application No. 60/376,655, filed on Apr. 30, 2002.

(51) Int. Cl. G06F 17/60

(52) U.S. Cl. 705/3

(57) ABSTRACT

An automated messaging system for use with a healthcare facility system for automatically providing clinicians associated with the facility alerts or messages upon certain patient centered events occurring. The healthcare facility system preferably clinicians access to electronic medical charts for each patient. The alerts can be placed onto Information Summary screens or windows provided for each clinician.

### RELATED APPLICATIONS

The present application claims priority from U.S. Patent Serial No. 60/377,027 filed Apr. 30, 2002; U.S. Patent Serial No. 60/376,625, filed Apr. 30, 2002; U.S. Patent Serial No. 60/376,655, filed Apr. 30, 2002; and U.S. patent Ser. No. 10/135,180 filed Apr. 30, 2002, which is a continuation-in-part of copending U.S. patent Ser. No. 10/059,929 filed Jan. 29, 2002, and incorporates such applications herein by reference.

Additionally, the present application is being filed concurrently with and incorporates by reference the following applications: “System And Method For Obtaining Information From A Bar Code For Use With A Healthcare System” (Attorney Docket No. EIS-5897 (1417G P 754)), Ser. No. ______; “Infusion Therapy Bar Coding System and Method” (Attorney Docket No. EIS-5850 (01417GP0750)), Ser. No. ______; “System and Method for Providing Multiple Units of Measurement” (Attorney Docket No. EIS-5851(1417GP0751)), Ser. No. ______; “Nursing Order Workflow System and Method” (Attorney Docket No, EIS-5899(1417GP0756)), Ser. No. ______; “Healthcare Database Management Offline Backup and Synchronization System and Method” (Attorney Docket No. EIS-5895(1417G-P752)), Ser. No. ______; “Biometric Security For Access To A Storage Device For A Healthcare Facility” (Attorney Docket No. EIS-5847(1417G-P720)), Ser. No. ______; “Storage Device For Health Care Facility” (Attorney Docket No. EIS-5848(1417G P 747)), Ser. No. ______; “System And Method For Supporting Clinical Decisions During Patient Care And Treatment” (Attorney Docket No. EIS-5896(1417G-P753)), Ser. No. ______; “System And Method For Facilitating Patient Care And Treatment” (Attorney Docket No. EIS-5898(1417G-P755)), Ser. No. ______; “System And Method For Facilitating Orders During Patient Care And Treatment” (Attorney Docket No. EIS-5900(1417G-P757)), Ser. No. ______; and, “Pharmacy System And Method” (Attorney Docket No. EIS-5901(1417G-P758)), Ser. No. ______.

### TECHNICAL FIELD

The present invention is generally directed to a message system designed for implementation with a healthcare facility system, and more particularly, to an automated messaging center for providing real time patient centered alerts or messages to clinicians associated with the patient.

### BACKGROUND OF THE INVENTION

Due to the paper nature of patient charts in the typical hospital or healthcare facility environment, the ability to automatically message appropriate healthcare providers (i.e., clinicians) on a real-time point of care electronic system concerning alerts on a patient's status has been unavailable. Furthermore, the traditional use of disparate systems (e.g., paper and/or electronic) to view a patient's total status precludes a single source for patient status messaging to appear.

Generally, clinical documentation relating to a patient has been completed directly on the patient's chart through traditional handwriting. Therefore, automated messaging to appropriate healthcare providers regarding entry of new documentation on a patient's chart was inconceivable.

Today, some electronic clinical documentation systems exist. However, such systems have not provided the real-time automated new clinical documentation message directly to the appropriate healthcare provider. For example, in prior practice a clinician was required to constantly query a system to determine if laboratory and radiology results were available. Such results were not automatically provided to the appropriate healthcare providers.

### SUMMARY OF THE INVENTION

The present system includes a messaging center through which clinicians can access automated patient centric alerts and internal patient centric and personal email. Through the systems real-time event management, clinicians immediately have access to patient-care related needs and activities at any instant in time. The system includes a number of options for automated alert event-driven messaging. Clinicians can customize the types of automated messaging to appear by message type and severity of abnormality. As well, the system provides flexibility for the healthcare provider to determine if the message should be audible and/or visual, and whether it should appear during system use as a pop-up (multi-tasking) window or only appear on the Information Summary windows.

In one embodiment, an automated messaging system for use with an electronic healthcare facility system at a healthcare facility comprises a healthcare facility system which maintains a plurality of electronic medical records, each record associated with a patient and containing clinical information regarding the patient. The healthcare facility may be, for example, a hospital, clinic, nursing home, and in some instances may include home care of a patient. The healthcare facility system provides access for a plurality of clinicians to information maintained in the healthcare facility system. The messaging system further comprises a messaging center for selectively automatically generating messages to the plurality of clinicians, the messages being available on a real time basis without the need for the clinicians to query the messaging center to determine availability of said messages. Instead, the messages are preferably placed on an Information Summary screen or window provided for each clinician. The Information Summary screen is one of the screens available to a clinician when they log onto the healthcare facility system. The messaging center is selective in that it determines the appropriate clinicians within the healthcare facility to direct specific alerts or messages. Typically, messages or alerts are only sent to those clinicians associated with the patient at issue, or to all of the clinicians in a unit where the patient is located or that is otherwise responsible for some aspect of the patient's care or treatment.

The messaging system can automatically generate a message to one or more clinicians associated with a specific patient upon a change to the specific patient's electronic medical record. This change may be made by an attending nurse or other clinician at the healthcare facility. The change to the electronic medical record may be an unresolved intervention status (i.e., a recommendation for a course of treatment for the patient). Other clinicians associated with the patient can then respond to the unresolved intervention.

While the term “clinician” is sometimes used to only refer to the physicians, nurses and other technical personnel associated with patient care, the term is being used herein to refer to any person in the healthcare domain that would utilize information provided by the alert system. For example, the janitorial staff may be alerted when the healthcare facility system receives a notice or message from the admitting, discharge and transfer system that a patient has checked out. The alert notifies the staff to proceed with cleaning the patient's former room. Another use may be to inform mothers who have just given birth when their baby is crying.

The healthcare facility system can be linked to other electronic systems associated with the healthcare facility. For example, the healthcare facility system can include an interface to a laboratory system, a radiology system, and an admitting, discharge and transferring system (ADT).

From the interface with the laboratory system, laboratory results relating to a patient at the healthcare facility can be sent electronically from the laboratory system as a message to the messaging center (either directly or through the healthcare facility system). The messaging center then alerts clinicians associated with the patient of the laboratory message and/or the availability of the laboratory results. Additionally, the messaging center can place the laboratory message on the patient's electronic medical record or Information Summary. The laboratory results relating to a patient at the healthcare facility may also include an abnormal flag. Either the healthcare facility or the clinicians can limit the messaging system so that the messaging center only alerts the clinicians associated with the patient when the abnormal flag is within a predetermined range. Similar functionality can also be provided for results received from the radiology system.

Additionally, transactions from the admitting, discharge and transferring system can be electronically sent to the messaging center. The messaging center can then place the message on a patient's Information Summary screen, or the appropriate clinician's screens (if known).

The messaging center can also generate an alert or message to clinicians associated with a patient upon entering of structured clinical documentation results to a electronic medical chart associated with the patient. The message can be associated with an abnormal flag. Again, the system can be designed to only provide the alert if the abnormal flag is within a certain range.

The messaging center can also generate a message to clinicians associated with a patient upon entering of new clinical documentation notes to a electronic medical chart associated with said patient.

The messaging center can provide alerts to a particular clinician via the clinician's pager.

In another embodiment, an automatic messaging system for use with a healthcare facility system comprises a message center associated with a healthcare facility system. The healthcare facility system being capable of maintaining a plurality of electronic medical records for a corresponding plurality of patients and providing access to the healthcare facility system to a plurality of clinicians. The messaging center is configured to automatically provide electronic alerts to at least one of the plurality of clinicians upon predetermined events relating to a patient. The messaging system can also provide such alerts to additional clinicians of the plurality of clinicians (e.g., those associated or otherwise treating or caring for the patient at issue). Other similar functionality as described with the embodiment above, can also be implemented with this another embodiment.

Further aspects of the invention are disclosed in the detailed description of the preferred embodiment, the drawings and the claims.

### BRIEF DESCRIPTION OF THE DRAWINGS

FIG. 1 is a screen shot of an Information Summary screen in accordance with the present invention;

FIG. 2 is a screen shot of another Information Summary screen in accordance with the present invention;

FIG. 3 is a screen shot of a computerized physician order entry screen with a clinical documentation module; and,

FIG. 4 is a screen shot of a list of abnormal flags.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present messaging system and method is preferably used in connection with a medical delivery and information management system for use in hospitals, and other similar healthcare facilities (i.e., a healthcare facility system). The preferred healthcare facility system uses a combination of bar coding and wireless technology to support the clinical needs of physicians, pharmacists, nurses and other healthcare personnel (i.e., clinicians). Moreover, the preferred healthcare system allows healthcare professionals and administrators to make better decisions and reduce costs, while improving patient safety and quality of care.

Specifically, among other things, the preferred healthcare system comprises a computer software program integrated with various other healthcare facility systems, that provides for: electronic on-line access to patient information (e.g., medication history, current medications, allergies, reactions) and medication administration information, preferably in the form of an electronic medical record for the patient; instant medication ordering at the patient bedside; clinical screening of medications; an electronic messaging link between physicians, pharmacists and nurses; standardized dosage and special administration instructions; and, an improved quality of record keeping and inventory tracking. Functionality included within the healthcare system is split between end-user workstations, medication carts with computer interfaces and hand-held computerized devices (e.g., electronic tablets or personal digital assistants). The hand-held devices are preferably operated at the patient bedside.

The present messaging system interfaces with the healthcare facility system to provide messaging functionality to the users of the healthcare facility system. From a programing standpoint, the messaging system can be set up either as a completely separate application that interacts with the healthcare facility system, or as a sub-component or sub-program of the healthcare facility system. Conventional software code can be used to implement the unique functionality of the messaging system described herein. The code can be provided on any computer readable medium.

The messaging system comprises a messaging center which is configured to automatically provide patient centered alerts or messages to specific clinicians associated with the healthcare facility upon the occurrence of certain events. The clinicians at the healthcare facility may comprise doctors (e.g., attending physician, ordering physician, etc.), nurses, and other healthcare professionals that assist in the care of the patients at the facility. The clinicians can be placed in groups (e.g., a nursing shift comprising a plurality of nurses) or units (i.e., all clinicians associated with a particular department in the facility). The clinicians are provided access to the healthcare facility system from any of the workstations, cart interfaces or hand-held devices. Once the clinician is logged onto the healthcare facility system, the clinician is able to view a personal Information Summary window or screen. The clinician is also able to access a patient's electronic medical record.

The messaging system provides automated alert event-driven messages. Preferably, clinicians can customize the types of automated messaging to appear by message type and/or severity of abnormality. Additionally, the system can be modified to allow for audible and/or visual messaging, and whether a message should appear during system use as a pop-up window, or only appear on the Information Summary window or screen.

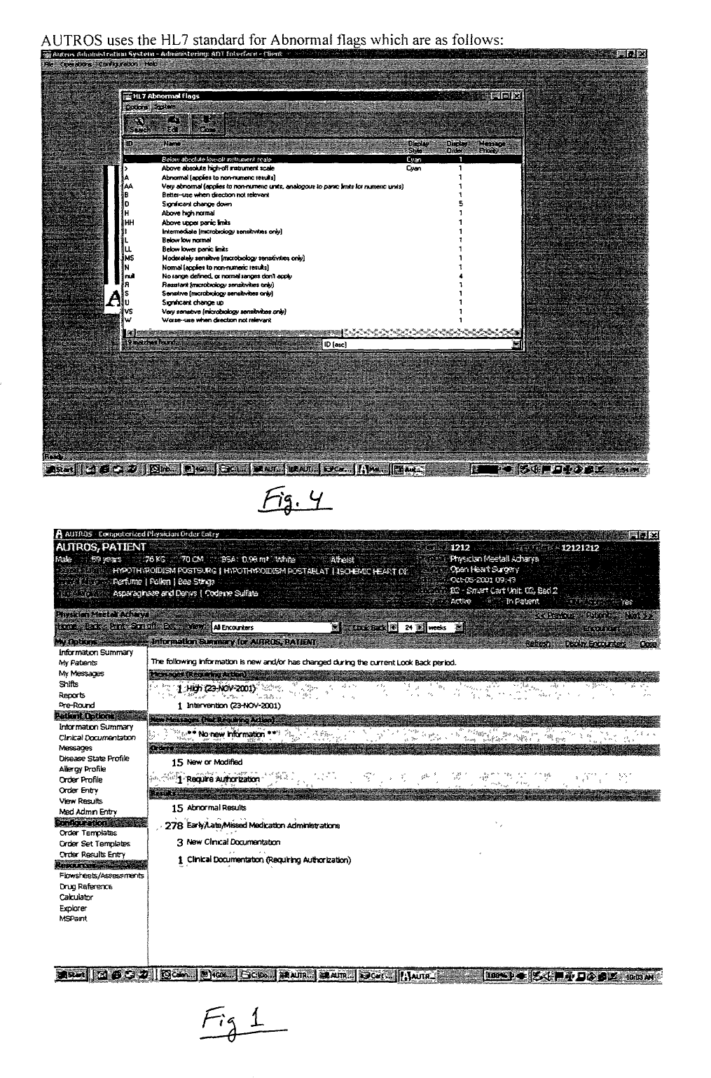

FIGS. 1 and 2 both show Information Summary screens. The screen in FIG. 1 identifies a specific patient, while the screen in FIG. 2 is not patient specific.

Clinical Intervention Unresolved

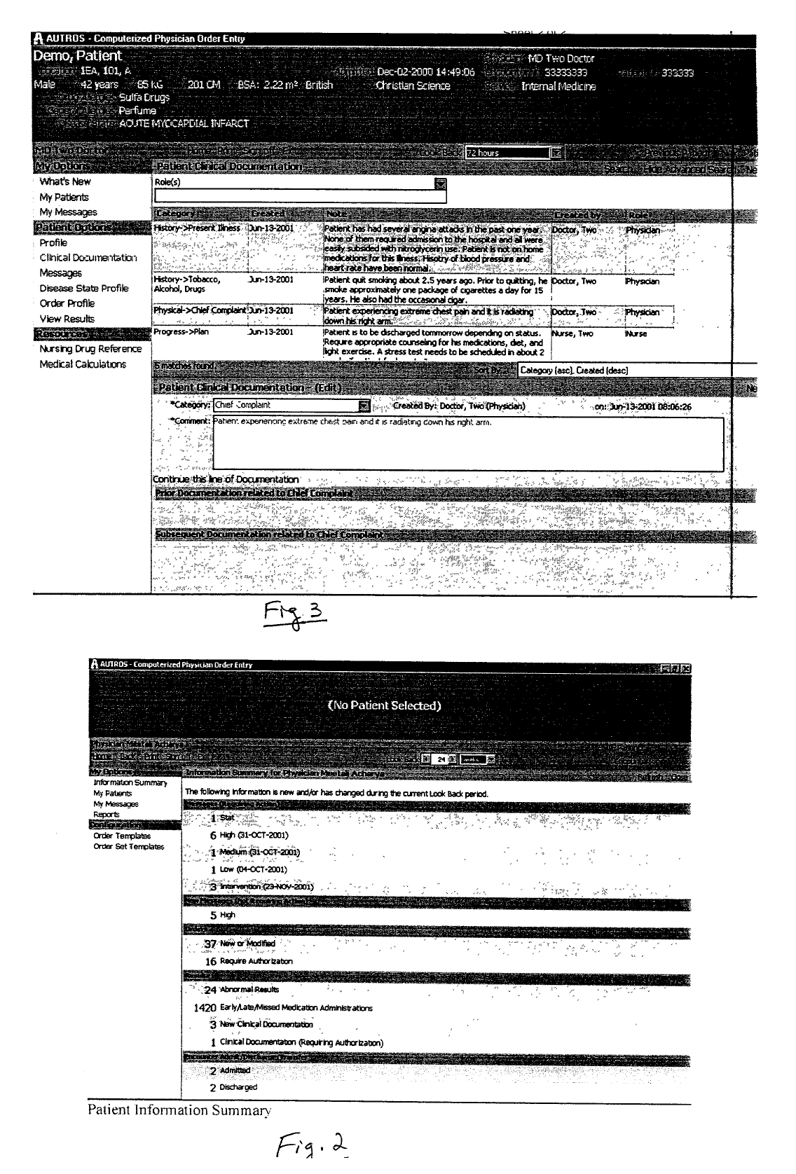

The messaging center automatically provides an alert when a patient intervention (some procedure or other contact with a patient by one or more clinician) is recorded in the patient's electronic medical record maintained by the healthcare facility system. A record of an example intervention is demonstrated in the screen shot of FIG. 3. The alert is provided to those clinicians that are or become responsible, or are otherwise associated with the particular patient at issue (e.g., attending physician, nurse on current shift, unit clinicians).

Specifically, a Clinical Intervention module within the healthcare facility system's application allows clinicians, pharmacists, and nurses to document an intervention concerning a patient's therapy on the patient's electronic medical record. The intervention includes an ability to assess the patient, indicate potential problems with therapy, provide recommendations, and a follow-up procedure. When recommendations are made and the status of the intervention is open or unresolved, the clinician receives a message in real-time generated by the messaging center concerning the open intervention and can then respond to it by either accepting the recommendation or entering a subsequent recommendation and altering therapy accordingly. The real-time clinical intervention unresolved message can be retrieved on a workstation, a tablet, or a PDA. As well, the environment can be wireless.

FIG. 1 shows that the physician (for the particular Information Summary screen) has one intervention noted for the selected patient. FIG. 2 shows three total intervention notices.

Lab Result Reporting

The healthcare facility system can interface with other systems used at or with the healthcare facility. For example, the healthcare facility system typically interfaces to a hospital's laboratory system to obtain laboratory results. This interface is real-time and therefore as soon as results are sent to the healthcare facility system, they go through the messaging center to alert the appropriate clinicians that results are available. The healthcare facility system's Information Summary—area in which alert messaging is displayed—can be oriented to be clinician specific, unit specific, or patient specific. For instance, when a laboratory result for a specific patient is received, the system determines which clinicians need to see this result based on attending physician, ordering physician, nursing shift etc. and then places this alert message on their Information Summary. Similarly, when the Information Summary is viewed in a unit specific manner, the results for all patients on that particular unit are messaged. The patient Information Summary view only displays alert messaging for that particular patient.

Abnormal Lab Result Reporting

The results coming across the laboratory interface may include an abnormal flag, such as a Health Level Seven Abnormal Flag. The messaging system allows the hospital and/or clinician to determine which results should appear as alert messages based on their abnormal flags. For example, a clinician may indicated that a Very High abnormal flagged result be messaged to him/her; however, maybe an Above High Normal flagged result is not necessary to be messaged. A list of various abnormal flags that can be used is shown in FIG. 4. Multiple alerts can be divided on the particular Information Summary (e.g., physician, nurse, patient) by the abnormal flag attached to each result.

Health Level Seven is one of several ANSI-accredited Standards Developing Organizations (SDOs) operating in the healthcare arena. Most SDOs produce standards (sometimes called specifications or protocols) for a particular healthcare domain such as pharmacy, medical devices etc. Health Level Seven is headquartered in Ann Arbor, Mich.

Abnormal Structured Clinical Documentation Results

The Clinical documentation module of the healthcare facility application includes an end user forms wizard, which allows the healthcare facility to customize its patient documentation. The system allows definition of the ranges—using only one side of the range such that all inclusive numbers are automatically included rather than the user trying to ensure that all in between values have been covered. After being defined, the system ensures that all rows are sorted appropriately. Next to the range defined, an Abnormal Flag column exists in which the healthcare facility can define the HL7 abnormal flag associated with the range. The healthcare facility can also define a preferred color for each HL7 abnormal flag.

When structured clinical documentation is entered on a patient's profile, the healthcare facility system in real-time assesses the abnormal flag of the result entered and depending on the healthcare facility and/or clinician settings, posts it to the messaging center to alert the appropriate clinicians that abnormal results are available. The healthcare facility system allows the healthcare facility and clinician to determine which results should appear as alert messages based on their abnormal flags. For example, a clinician may indicated that a Very High abnormal flagged result be messaged to him/her; however, maybe an Above High Normal flagged result is not necessary to be messaged.

Structured Clinical Documentation Results

When structured clinical documentation is entered on a patient's profile (i.e., electronic medical record), the healthcare facility system in real-time pushes a message to appropriate users (clinicians) that structured clinical documentation results have been entered. The direction/placement of the message is dependent on the hospital and/or clinician settings.

New Clinical Documentation

The healthcare system's clinical documentation preferably includes maintenance of patient notes either through direct entry or through a transcription interface, termed free text clinical documentation. Moreover, the healthcare facility system's clinical documentation application preferably allows the healthcare facility to define categorical trees for clinical documentation purposes in order to better able accommodate searching and reporting functionality. These categories can be set to represent those that the healthcare facility currently uses with its paper charts. To facilitate quick searching and reporting, the healthcare facility system's clinical documentation application preferably allows filtering of patient notes based on a look back period, selected categories, and user roles. A clinical documentation patient note is comprised of the following information: category information, the patient note, entered date/time and personnel entering, authoring date/time and personnel authoring/verifying, and the patient encounter in which the note was documented. When a new clinical documentation note has been entered on a patient's profile, the message center provides an alert message which will notify the appropriate clinician(s) on his/her Information Summary.

New Clinical Documentation Requiring Sign Off

When there is a note transcribed on the clinician's behalf, the healthcare facility alert messaging system will notify the clinician on the clnician's Information Summary.

Admitting/Discharging Alert Messaging

The healthcare facility system is also typically interfaced to the healthcare facility system's Admitting, Discharge, and Transferring (ADT) system through a Health Level Seven interface. When the healthcare facility system receives an ADT transaction, it places an according message on the Information Summary screens for the appropriate clinician(s).

New Radiology Report Results Received

The healthcare facility system also typically interfaces to the healthcare facility's radiology system to obtain radiology results. This interface is real-time and therefore as soon as results are sent to the healthcare facility system, they go through the messaging center to alert the appropriate clinician(s) that results are available.

Abnormal Radiology Report Results Received

The results coming across the interface with the radiology system may include a Health Level Seven Abnormal Flag. The healthcare facility system or the messaging system allows the healthcare facility and/or clinician(s) to determine which results should appear as alert messages based on their abnormal flags.

The messaging center includes the ability to push all of the alert(s) described herein at the end-user instead of the user having to constantly query the system to determine if a result is available or not. In addition to the above functionality, the messaging center can include an email-type program to send the previously discussed automated alerts or messages (in addition to or instead of placing the alert or message on the appropriate Information Summary(s)), or other personal e-mail between clinicians. The messaging system can also send the automated alerts or messages to a printer in addition to or rather than an electronic system.

The healthcare facility system and/or the messaging system can be Interfaced with other systems to allow each such other system to send its messaging to a patient's electronic medical record. Additionally, the messaging center can also be provided with functionality to send the above mentioned automated alerts or messages to a phone or pager of the clinician(s), through visual and/or audible cues.

While specific embodiments have been illustrated and described, numerous modifications are possible without departing from the spirit of the invention, and the scope of protection is only limited by the scope of the accompanying claims.

What is claimed is:

1. An automated messaging system for use with an electronic healthcare facility system at a healthcare facility comprising:
a healthcare facility system which maintains a plurality of electronic medical records, each said record associated with a patient and containing clinical information regarding said patient, said healthcare facility system providing access for a plurality of clinicians to information maintained in said healthcare facility system; and,
a messaging center for selectively automatically generating messages to said plurality of clinicians, said messages being available on a real time basis without the need for said clinicians to query said messaging center to determine availability of said messages.

2. The system of claim 1 wherein a message is automatically generated to a clinician associated with a specific patient upon a change to said patient's electronic medical record.

3. The system of claim 2 wherein said change is an unresolved intervention status.

4. The system of claim 2 wherein said message is placed on an information summary page for said clinician.

5. The system of claim 1 wherein said healthcare facility system is linked to other electronic systems associated with said healthcare facility.

6. The system of claim 5 wherein said healthcare facility system is linked to a laboratory system associated with said healthcare facility.

7. The system of claim 6 wherein laboratory results relating to a patient at said healthcare facility are sent electronically from said laboratory system as a message to said messaging center, and wherein said messaging center alerts clinicians associated with said patient of said laboratory message.

8. The system of claim 7 wherein said messaging center places said laboratory message on said patient's electronic medical record.

9. The system of claim 7 wherein said messaging center places said laboratory message on an information summary for each of said clinicians associated with said patient.

10. The system of claim 6 wherein laboratory results relating to a patient at said healthcare facility which include an abnormal flag are sent electronically from said laboratory system as a message to said messaging center, and wherein said messaging center alerts clinicians associated with said patient when said abnormal flag is within a predetermined range.

11. The system of claim 1 wherein said messaging center generates a message to clinicians associated with a patient upon entering of structured clinical documentation results to a electronic medical chart associated with said patient.

12. The system of claim 11 wherein said message is associated with an abnormal flag.

13. The system of claim 1 wherein said messaging center generates a message to clinicians associated with a patient upon entering of new clinical documentation notes to a electronic medical chart associated with said patient.

14. The system of claim 5 wherein said healthcare facility system is linked to a patient admitting, discharge and transferring system associated with said healthcare facility.

15. The system of claim 14 wherein transactions from said admitting, discharge and transferring system are electronically sent to said messaging center, and wherein said messaging center places said message on an information summary.

16. The system of claim 5 wherein said healthcare facility system is linked to a radiology system associated with said healthcare facility.

17. The system of claim 16 wherein radiology results relating to a patient at said healthcare facility are sent electronically from said radiology system as a message to said messaging center, and wherein said messaging center alerts clinicians associated with said patient of said radiology message.

18. The system of claim 16 wherein radiology results relating to a patient at said healthcare facility which include an abnormal flag are sent electronically from said radiology system as a message to said messaging center, and wherein said messaging center alerts clinicians associated with said patient when said abnormal flag is within a predetermined range.

19. The system of claim 1 wherein said messaging center alerts a particular clinician of said plurality of clinicians of a message via a pager.

20. The system of claim 5 wherein said messaging center places messages received from said other electronic systems regarding a particular patient on one of said plurality of electric medical records associated with said particular patient.

21. The system of claim 1 wherein said messaging center generates messages for all clinicians within a hospital defined unit.

22. An automatic messaging system for use with a healthcare facility system comprising:
a message center associated with a healthcare facility system capable of maintaining a plurality of electronic medical records for a corresponding plurality of patients and providing access to said healthcare facility system to a plurality of clinicians, said messaging center configured to automatically provide electronic alerts to at least one of said plurality of clinicians upon predetermined events relating to a patient.

23. The messaging system of claim 22 wherein said messaging center automatically provides an electronic alert to additional ones of said plurality of clinicians.

24. The messaging system of claim 22 wherein said at least one of said plurality of clinicians is a physician.

25. The messaging system of claim 22 wherein said at least one of said plurality of clinicians is a nurse.

26. The messaging system of claim 22 wherein said healthcare facility system is configured to provide an information summary screen for each of said plurality of clinicians.

27. The messaging system of claim 26 wherein said messaging center provides said alert to an information screen for said at least one of said plurality of clinicians.

28. The messaging system of claim 27 wherein said messaging center provides said alert to said information screen for said at least one of said plurality of clinicians upon receipt of laboratory results from a laboratory system interfaced with said healthcare facility system.

29. The messaging system of claim 27 wherein said messaging center provides said alert to said information screen for said at least one of said plurality of clinicians upon receipt of radiology results from a radiology system interfaced with said healthcare facility system.

30. The messaging system of claim 27 wherein said messaging center provides said alert to said information screen for said at least one of said plurality of clinicians upon receipt of a transaction from an admitting, discharge and transferring system interfaced with said healthcare facility system.

31. The messaging system of claim 27 wherein said messaging center provides said alert to said information screen for said at least one of said plurality of clinicians upon modification of an electronic medical record of a patient associated with said at least one of said plurality of clinicians.

32. The messaging system of claim 31 wherein said modification is an open intervention.

33. The messaging system of claim 31 wherein said modification is structural clinical documentation.

34. The messaging system of claim 28 wherein said laboratory results include an abnormal flag within a predetermined range.

35. The messaging system of claim 29 wherein said radiology results include an abnormal flag within a predetermined range.

36. The messaging system of claim 33 wherein said structural clinical documentation includes an abnormal flag within a predetermined range.

37. The messaging system of claim 23 wherein said healthcare facility system is configured to provide an information summary screen for each of said plurality of clinicians.

38. The messaging system of claim 37 wherein said messaging center provides said alert to an information screen for a first clinician and a second clinician.

39. The messaging system of claim 38 wherein said messaging center provides said alert to said information screen for said first clinician and said second clinician upon receipt of laboratory results from a laboratory system interfaced with said healthcare facility system.

40. The messaging system of claim 38 wherein said messaging center provides said alert to said information screen for said first clinician and said second clinician upon receipt of radiology results from a radiology system interfaced with said healthcare facility system.

41. The messaging system of claim 38 wherein said messaging center provides said alert to said information screen for said first clinician and said second clinician upon receipt of a transaction from an admitting, discharge and transferring system interfaced with said healthcare facility system.

42. The messaging system of claim 38 wherein said messaging center provides said alert to said information screen for said first clinician and said second clinician upon modification of an electronic medical record of a patient associated with said first clinician and said second clinician.

43. The messaging system of claim 38 wherein said first clinician and said second clinician are part of a same unit.

44. A software program on a computer readable medium for an automated messaging system for use with an electronic healthcare facility system at a healthcare facility comprising:
a first software code portion for implementing a healthcare facility system which maintains a plurality of electronic medical records, each said record associated with a patient and containing clinical information regarding said patient, said healthcare facility system providing access for a plurality of clinicians to information maintained in said healthcare facility system; and,
a second software code portion form implementing a messaging center for selectively automatically generating messages to said plurality of clinicians, said messages being available on a real time basis without the need for said clinicians to query said messaging center to determine availability of said messages.

45. A software program on a computer readable medium for an automatic messaging system for use with a healthcare facility system comprising:
a first program portion for implementing a message center associated with a healthcare facility system capable of maintaining a plurality of electronic medical records for a corresponding plurality of patients and providing access to said healthcare facility system to a plurality of clinicians, said messaging center configured to automatically provide electronic alerts to at least one of said plurality of clinicians upon predetermined events relating to a patient.

46. A software program on a computer readable medium for an automatic messaging system for use with a healthcare facility system comprising:
a first program portion for receiving information relating to an electronic event occurring with a healthcare facility system regarding a patient; and,
a second program portion for automatically sending an alert in real time to a clinician associated with said patient regarding said electronic event.

47. The software program of claim 46 wherein said electronic event is a modification to a particular patient's electronic chart.

48. The software program of claim 46 wherein said electronic event is a laboratory result for a particular patient received from a laboratory system.

49. The software program of claim 46 wherein said electronic event is a radiology result for a particular patient received from a radiology system.

50. The software program of claim 46 wherein said electronic event is receiving a message from an admitting, discharging and transferring system.

51. A method for providing an automatic messaging system for use with a healthcare facility system comprising:
electronically receiving information relating to an electronic event occurring with a healthcare facility system regarding a patient; and,
automatically sending an electronic alert in real time to a clinician associated with said patient regarding said electronic event.

52. The method of claim 51 wherein said electronically receiving step comprises receiving information relating to an intervention to an electronic medical record for said patient.

53. The method of claim 51 wherein said electronically receiving step comprises receiving laboratory results regarding said patient from a laboratory system.

54. The method of claim 51 wherein said electronically receiving step comprises receiving radiology results regarding said patient from a radiology system.

55. The method of claim 51 wherein said electronically receiving step comprises receiving a message from an admitting, discharging and transferring system.

56. The method of claim 51 wherein said automatically sending step comprises placing a message on an information summary screen for said clinician.
